(19) United States
(12) Patent Application Publication
(10) Pub. No.: US 2025/0053371 A1
(43) Pub. Date: Feb. 13, 2025

(54) Coordination Between Media End Devices

(71) Applicant: Bose Corporation, Framingham, MA (US)

(72) Inventors: Rameshwar Sundaresan, Shrewsbury, MA (US); Tobe Z. Barksdale, Bolton, MA (US); Naganagouda B. Patil, Ashland, MA (US)

(73) Assignee: Bose Corporation, Framingham, MA (US)

(21) Appl. No.: 18/723,040

(22) PCT Filed: Dec. 16, 2022
(86) PCT No.: PCT/US2022/053181

§ 371 Date: Jun. 21, 2024

Related U.S. Application Data
(60) Provisional application No. 63/292,075, filed on Dec. 21, 2021.

(51) Int. Cl. G06F 3/16; H04M 1/00; H04M 1/60

(52) U.S. Cl. CPC G06F 3/165; H04M 1/006; H04M 1/6091; H04M 2250/02

(57) ABSTRACT

Systems and methods are presented to allow coordination between media end devices such that a user interface on a first end device may be used to manage audio calls, media playback, or the like, on a second end device. The first end device establishes a first communications channel to a source device and a second communications channel to a second end device. The second end device may also have a communications channel to the source device. The first end device communicates with the second end device on the second communications channel to exchange command and control information to influence operation between the second end device and the source device. The source device, however, is unaware of the second communications channel between the first and second end devices.

### CROSS-REFERENCE TO RELATED APPLICATIONS

This application claims the priority to PCT Application Serial Number PCT/US2022/053181, filed on Dec. 16, 2022, entitled “COORDINATION BETWEEN MEDIA END DEVICES”, which claims priority to U.S. Provisional Patent Application Ser. No. 63/292,075, filed on Dec. 21, 2021, entitled “COORDINATION BETWEEN MEDIA END DEVICES”, the entire contents of which are incorporated herein in their entirety for all purposes.

### BACKGROUND

With the widespread adoption of connected smart devices, such as smart phones, tablets, laptops, portable speakers, headphones (wearable audio devices), smart watches, and the like, the use of multiple such devices has become ubiquitous. It is common for at least one device to be a ‘source’ device, e.g., for media content and/or communications connections such as telephone calls (e.g., a smart phone), and multiple ‘sink’ devices, also referred to herein as media end devices, such as a portable speaker, wearable audio (e.g., headphones, earbuds, open-ear audio devices, etc.), or a car audio system. Often a telephone call or a media playback may be routed to the “wrong” media end device (audio sink) based upon where a user wants the call or media to be routed. Accordingly, there exists a need for improved capability for a user to manage media connections among multiple end devices.

### SUMMARY

Systems and methods disclosed herein are directed to coordination between multiple media end devices to improve user functionality and user interfaces for managing media playback and telephone call functionality from a source device, such as a smart phone or other suitable device.

According to at least one aspect, a first end device that is an audio system is provided that includes a first communications channel to a source device and a second communications channel to a second end device. The second end device may also have a communications channel to the source device. The first end device communicates with the second end device on the second communications channel to exchange command and control information that may influence operation between the second end device and of the source device. The source device, however, may be unaware of the second communications channel between the first and second end devices.

Accordingly, and as a first example, a user may select to answer a phone call using an interface on the first end device, the first end device can communicate to the second device on the second communications channel to instruct the second end device to answer the call, and the second end device communicates with the source device to answer and route the call to the second end device.

As a more specific example, a user may be in an automobile with a car audio system that includes a user interface and a connection to a cell phone, e.g., via Bluetooth, and the use may also be wearing an open-car audio wearable, such as glasses with integrated speakers, or an over-ear or in-ear open-ear wearable, the open-ear wearable also has a connection to the cell phone. The user may want to use the car's user interface to manage phone calls, but may also want the call audio to be routed to the open-ear wearable for privacy reasons (or simply to not bother other car occupants). With the advantage of systems and methods disclosed herein the car audio system may communicate with the wearable to coordinate the a management of various functions. Thus, for example, the user may select “answer” via the car's interface and the car audio system may communicate with the wearable to ‘instruct’ the wearable to answer the call, which is to say that the wearable, upon communication from the car audio system (or head unit), may operate as it normally would as if the user had taken action to ‘answer’ the call on the wearable directly.

Traditional car audio systems would not be able to accommodate such functionality. In convention systems, the user would have to use the wearable or the cell phone to control and route the call to the wearable, and then no user interface functions of the car would be effective, such as a mute button, volume control, or ‘end call’ option, would have no effect on the phone call that is connected to the wearable. With systems and methods disclosed herein, however, user interface selections made with the car audio system (or head unit) may be communicated to the wearable (and vice-versa).

As a further example, other media end devices such as portable speakers, speakerphones, etc., may also incorporate a second communications channel to a second end device to allow a user to use an interface on either end device to control operation of the other end device.

Still other aspects, examples, and advantages of these exemplary aspects and examples are discussed in detail below. Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification but are not intended as a definition of the limits of the invention(s). In the figures, identical or nearly identical components illustrated in various figures may be represented by a like reference character or numeral. For purposes of clarity, not every component may be labeled in every figure. In the figures:

FIG. 1 is a schematic diagram of communications channels between devices;

FIG. 2 is a schematic diagram of an example sequence of communications messages between the devices of FIG. 1;

FIG. 3 is a schematic diagram of another example sequence of communications messages between the devices of FIG. 1; and

FIG. 4 is a schematic diagram of another example sequence of communications messages between the devices of FIG. 1.

### DETAILED DESCRIPTION

### Aspects of the Present Disclosure are Directed to Systems and Methods

Systems and methods disclosed herein solve various challenges of using multiple end devices coupled to a source device. User preferences may be stored about a preferred one of the end devices to be used to connect calls, playback media, etc., and a phone call or media may be routed to the preferred end device even when the user interacts with the other end device. In other words, systems and methods disclosed herein allow a user to use an interface on one end device to control phone calls or media playback that is routed to a second end device. For example, an automotive interface or a portable speaker interface may be used to control a call or media routed to a wearable, or vice versa.

Such systems and methods herein can solve a pain point for users having multiple end devices (which may be Bluetooth media ‘sinks” for instance).

For example, a person on a call using Bluetooth headphones may enter their house where an out-loud Bluetooth speaker has speakerphone capability, and the person may prefer that the call be automatically transferred to the speakerphone as soon as they enter the house. Despite this preference, with conventional end devices the call stays on the headphones. With systems and methods disclosed herein, however, the two end devices (headphones and Bluetooth speaker) may establish a communications channel (a “back-channel”) and communicate with each other on the back-channel to facilitate a transfer of the call between the end devices. A similar interaction may operate substantially in reverse, for example if a user prefers to use headphones, and upon turning on the headphones the two end devices establish a communications channel and facilitate a transfer of the call from the speakerphone to the headphones.

Similarly, a user may have both an out-loud speaker and a wearable coupled to their cell phone when an incoming call is received. Generally, each of the out-loud speaker and the wearable will “ring” to indicate the incoming call. If the user selects “answer” on the out-loud speaker, in conventional systems the call audio will be routed to the out-loud speaker. If the user prefers to use the interface on the out-loud speaker but prefers the call audio to actually be routed to the wearable, systems and methods disclosed herein may achieve such desired functionality. For example, in systems and methods herein the two end devices (out-loud speaker and wearable) have novel capability to communicate and coordinate over a back-channel that allows the user to control routing of the call audio to their wearable via a user interface on the out-loud speaker.

A similar challenge may exist in an automotive environment, where, for example, a driver may have their family in car while driving and receives an incoming conference call for work. The driver may select “Answer” on a head unit interface or display. The driver may prefer the audio to go to her open-car wearable so as to keep the professional conversation private and to be non-disruptive to her family. With conventional systems, the audio is rendered through the car's audio system instead of the wearable. With systems and methods disclosed herein, however, a back-channel communication between the car's head unit (or audio system) and the wearable allows the two end devices (head unit and wearable) to coordinate routing the call to the wearable even though the driver “answered” the call on the car interface.

Another challenge in a conventional automotive environment involves a driver being on a phone call using an open-car wearable. If the driver wants to mute the call using the steering-wheel controls, such would be incapable using conventional systems because the car's mute control is unavailable, because the call is on the open-car wearable. Once again, with systems and methods disclosed herein, however, the two end devices (car audio system and wearable) have novel capability to communicate and coordinate over a back-channel that allows the user to control the mute functionality on the wearable via the mute control of the car's user interface.

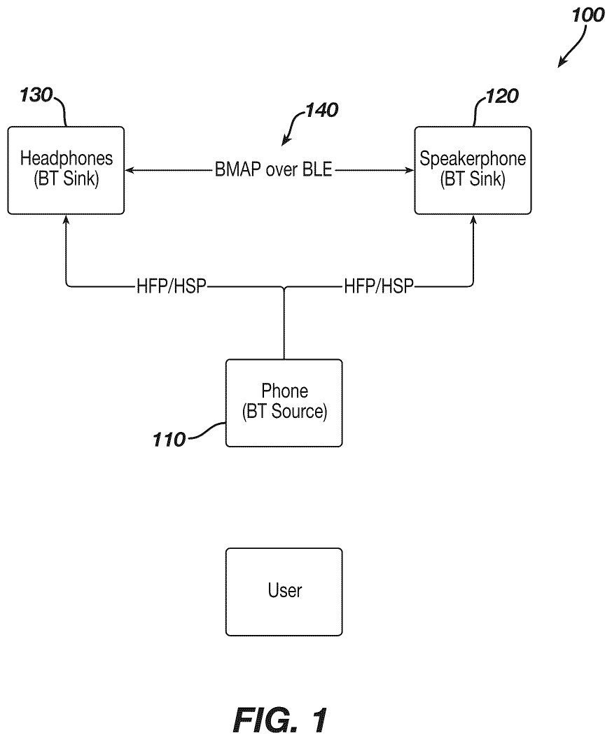

According to various examples, and with reference to FIG. 1, there is illustrated a user environment 100 that includes a source device 110, a first end device 120, and a second end device 130. As illustrated, the first end device 120 is a speakerphone and the second end device 130 is a headphone, each of which may be Bluetooth “sinks” for media playback or call audio routing. In other examples, the first end device 120 and the second end device 130 may be any suitable end device for receiving (and sending) media playback, call audio, or other content, generally at the control or direction of the source device 110. In certain examples, the first end device 120 may be a head unit or audio system of an automobile. In various examples, either of the first end device 120 or the second end device 130 may include a user interface, and a user may prefer to use either user interface to “control” operation of the other end device.

Conventionally, each of the end devices 120, 130 may establish a communications link with the source device 110, illustrated in FIG. 1 as establishing a Hands-Free Profile (HFP) or Handset Profile (HSP) as known in wireless Bluetooth communications standards.

However, unlike conventional systems, in the user environment 100 the first end device 120 and the second end device 130 may establish a communications channel 140 between themselves, illustrated as “BMAP over BLE” in FIG. 1, but communications channel 140 may be any suitable communications channel or may carry any suitable protocol for the exchange of control messages, in various examples. For reference, BMAP may be a proprietary protocol (e.g., data structure, packet format, etc.) of Bose Corporation and BLE is an abbreviation for Bluetooth Low Energy, as known in the art.

The communications channel 140 allows command/control messages to pass between the end devices 120, 130 without the need for the source device 110 to be aware. Conventionally, if a user wanted to use the user interface on the second end device 130 to control operation between the source device 110 and the first end device, the source device 110 would need to support such functionality. With the systems and methods described herein, however, the source device 110 need not be involved in coordination between the first and second end devices 120, 130.

With the arrangement illustrated, any user preference on where to take a call-to which end device call audio should be routed-is preserved. This preference may be exchanged over communications channel 140 as soon as the end devices are aware of each other. For example, when the user answers a call using a set of controls on either end device 120, 130, the call audio is connected to the preferred device, using standard HFP/HSP protocol messages. Regardless of device taking the call, the user interface on either device can fully control the call, because two end devices 120, 130, use the novel communications channel 140 to coordinate.

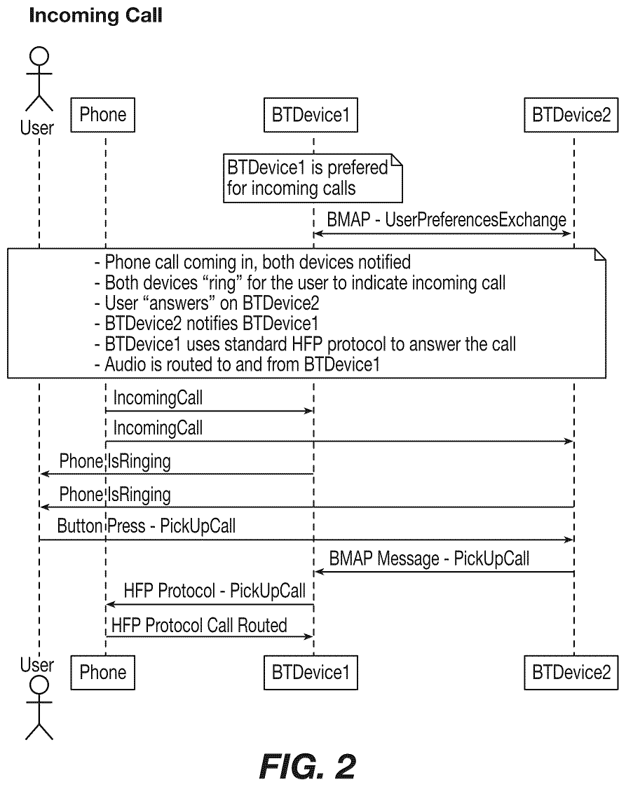

Turning to various examples of user interaction and example communication messages between the devices 110, 120, and 130, FIGS. 2-4 illustrate operation to achieve various user desired functionality using the systems and methods herein.

With reference to FIG. 2, an incoming call is received, and the user prefers to take the audio of the call on BTDevice1. However, the user prefers to use the user interface provided by BTDevice2. According to various examples, the user may “answer” the call by pressing the answer button on BTDevice2, but the call is actually routed to BTDevice1.

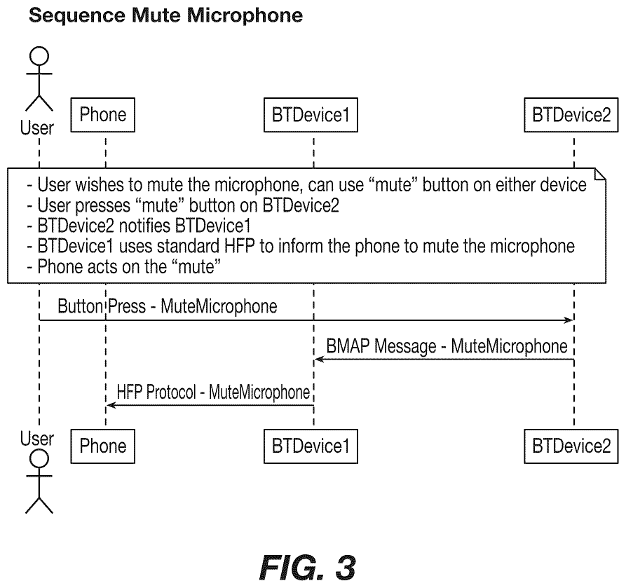

FIG. 3 illustrates an example sequence of user interaction and messages between the devices 110, 120, 130 that may allow the user interface on BTDevice2 to control the call though the call audio is routed through BTDevice1. In this example, the user uses the user interface on BTDevice2 to mute the microphone on BTDevice1. In similar examples, the user may use the user interface on BTDevice2 to adjust an output volume on BTDevice1.

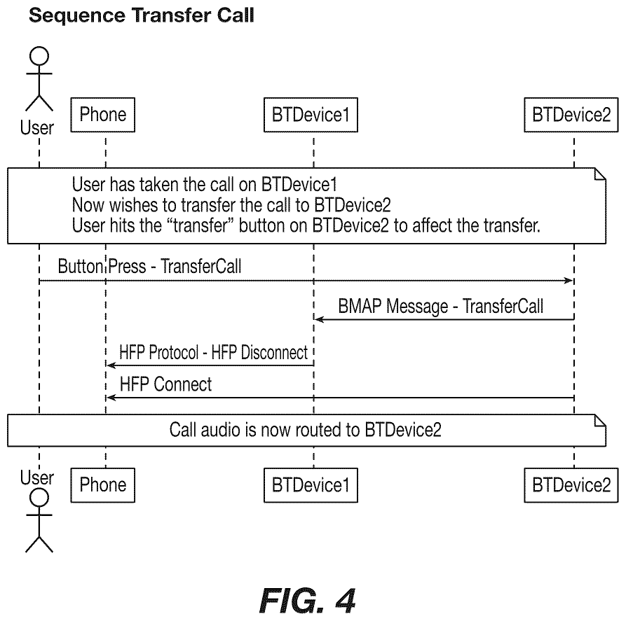

FIG. 4 illustrates an example sequence of user interaction and messages between the devices 110, 120, 130 that may allow the user interface on BTDevice2 to control the call to be transferred from BTDevice1 to BTDevice2.

Examples of the methods and apparatuses discussed herein are not limited in application to the details of construction and the arrangement of components set forth in the above descriptions or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Also, the phraseology and terminology used herein is for the purpose of description and should not be regarded as limiting. Any references to examples, components, elements, acts, or functions of the systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation, unless the context reasonably implies otherwise.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. An end device that is a first end device, comprising:
a first communications channel for coupling to a source device for the transfer of playback media or call audio; and
a second communications channel for coupling to a second end device, wherein the first end device communicates with the second end device on the second communications channel to exchange control information to influence operation between the second end device and the source device for the transfer of playback media or call audio between the second end device and the source device.

2. The end device of claim 1 wherein the first end device is one of a vehicle audio system and a wearable audio device, and the second end device is the other of a vehicle audio system and a wearable audio device.

3. The end device of claim 1 wherein the control information to influence operation between the second end device and the source device is configured to include one or more of answering a call, terminating a call, switching playback media between the first and second end devices, adjusting volume of the playback media, and muting a microphone.

4. The end device of claim 1 wherein the first end device includes a user configuration setting that indicates whether a user input at the first end device should influence the operation between the second end device and the source device, or that the user input should influence operation between the first end device and the second end device.

5. The end device of claim 4 wherein the user configuration setting is a persistent setting, which is a user selected default setting, being stored and associated with either of the first or second end device.

6. The end device of claim 5 further comprising a plurality of user selected default settings, wherein each of the user selected default settings dependent upon at least one of an identified one of a plurality of users, an identified one of a plurality of second end devices, and an identified presence of the one of the plurality of second end devices.

7. A method of controlling an end device, the method comprising:
establishing, by a first end device, a communications channel to a second end device; and
exchanging control information over the communications channel to influence operation between a source device and the second end device, for the transfer of playback media or call audio between the source device and the second end device.

8. The method of claim 7 wherein the first end device is one of a vehicle audio system and a wearable audio device, and the second end device is the other of a vehicle audio system and a wearable audio device.

9. The method of claim 7 wherein the control information to influence operation between the second end device and the source device is configured to include one or more of answering a call, terminating a call, switching playback media between the first and second end devices, adjusting volume of the playback media, and muting a microphone.

10. The method of claim 7 wherein the first end device includes a user configuration setting that indicates whether a user input at the first end device should influence the operation between the second end device and the source device, or that the user input should influence operation between the first end device and the second end device.

11. The method of claim 10 wherein the user configuration setting is a persistent setting, which is a user selected default setting, being stored and associated with either of the first or second end device.

12. The method of claim 11 further comprising a plurality of user selected default settings, wherein each of the user selected default settings dependent upon at least one of an identified one of a plurality of users, an identified one of a plurality of second end devices, and an identified presence of the one of the plurality of second end devices.

13. A non-transitory computer readable medium having instructions stored thereon that when executed by a suitable processor cause the processor to perform a method comprising:
establishing, by a first end device, a communications channel to a second end device; and
exchanging control information over the communications channel to influence operation between a source device and the second end device, for the transfer of playback media or call audio between the source device and the second end device.

14. The computer readable medium of claim 13 wherein the first end device is one of a vehicle audio system and a wearable audio device, and the second end device is the other of a vehicle audio system and a wearable audio device.

15. The computer readable medium of claim 13 wherein the control information to influence operation between the second end device and the source device is configured to include one or more of answering a call, terminating a call, switching playback media between the first and second end devices, adjusting volume of the playback media, and muting a microphone.

16. The computer readable medium of claim 13 wherein the first end device includes a user configuration setting that indicates whether a user input at the first end device should influence the operation between the second end device and the source device, or that the user input should influence operation between the first end device and the second end device.

17. The computer readable medium of claim 17 wherein the user configuration setting is a persistent setting, which is a user selected default setting, being stored and associated with either of the first or second end device.

18. The computer readable medium of claim 18 further comprising a plurality of user selected default settings, wherein each of the user selected default settings dependent upon at least one of an identified one of a plurality of users, an identified one of a plurality of second end devices, and an identified presence of the one of the plurality of second end devices.
